(19) United States
(12) Patent Application Publication
(10) Pub. No.: US 2006/0235941 A1
(43) Pub. Date: Oct. 19, 2006

(54) System and method for transferring web page data

(75) Inventors: Blaise Aguera Y Arcas, Seattle, WA (US); Julian Walker, Seattle, WA (US)

Correspondence Address: KAPLAN GILMAN GIBSON & DERNIER L.L.P., 900 ROUTE 9 NORTH, WOODBRIDGE, NJ, 07095, US

(73) Assignee: MICROSOFT CORPORATION, REDMOND, WA (US)

(21) Appl. No.: 11/392,387

(22) Filed: Mar. 29, 2006

Related U.S. Application Data
(60) Provisional application No. 60/666,142, filed on Mar. 29, 2005.
(60) Provisional application No. 60/670,510, filed on Apr. 12, 2005.

(51) Int. Cl. G06F 15/16

(52) U.S. Cl. 709/217

(57) ABSTRACT

A system and method are disclosed which may include accessing an Internet site by a proxy server; converting image data from the Internet site into a multiresolution representation; and transmitting the image data in said multiresolution representation to a client device.

### CROSS-REFERENCE TO RELATED APPLICATIONS

This application claims the benefit of U.S. Provisional Applications Ser. No. 60/666,142, filed Mar. 29, 2005, entitled “System and Method for Interactive Multiresolution Transfer of World Wide Web Content by Proxy”, and Ser. No. 60/670,510, filed Apr. 12, 2005, entitled “System and Method for Interactive Multiresolution Transfer of World Wide Web Content by Proxy”, both of which are incorporated by reference herein. This application is also related to the following U.S. non-provisional patent applications: application Ser. No. 10/790,253, filed Mar. 1, 2004, entitled “System and Method for Exact Rendering in a Zooming User Interface”, application Ser. No. 10/854,117, filed May 26, 2004, entitled “System and Method for Multiple Node Display”, application Ser. No. 10/803,010, filed Mar. 17, 2005, entitled “Methods and Apparatus for Navigating an Image”, application Ser. No. 11/141,958, filed Jun. 1, 2005, entitled “Efficient Data Cache”, application Ser. No. 11/247,513, filed Oct. 11, 2005, entitled “System and Method for Efficiently Encoding Data”, application Ser. No. 11/252,181, filed Oct. 17, 2005, entitled “System and Method for Managing Communication and/or Storage of Image Data”, and U.S. Provisional Application Ser. No. 60/553,803, filed Mar. 17, 2004, entitled “Methods and Apparatus for Employing Image Navigation Techniques to Advance Commerce”, all of which applications are hereby incorporated herein by reference.

### BACKGROUND OF THE INVENTION

It has long been recognized that browsing the Web on a small device, such as a Personal Digital Assistant(PDA) cellular phone, or wireless terminal, would be useful. The difficulties involved in implementing web browsing on such devices generally do not arise because of limitations in computing power. Rather such difficulties arise from the two following causes. First, the displays are usually very small, making it difficult for them to display web pages designed specifically for larger displays or windows (e.g., typically, at least 800×200 or 1024×768 pixels). Second, small wireless devices are typically connected to wide-area networks at low bandwidth, making traditional web browsing a nuisance due to the need to download HTML (Hypertext Markup Language) pages in their entirety before viewing them.

Some partial solutions to this problem exist. For example, one computer hardware manufacturer has designed a new platform for wireless delivery of content to small devices based on BREW (Binary Runtime Environment for Wireless). This kind of solution, however, requires that content providers agree to provide their content using BREW technologies, or that third-party content aggregators continually repackage existing content using formatting specialized to the content or application, again serving the results using BREW technologies.

Another partial solution is Opera For Mobile, in combination with Opera Mobile Accelerator and Small-Screen Rendering™. These technologies are based on a popular Web browser, Opera, which has been ported to mobile wireless platforms. Small-Screen Rendering™ attempts to reformat Web pages dynamically to fit within the horizontal dimension of the mobile terminal's display. Opera Mobile Accelerator uses a proxy server to access Web pages in their original HTML form on demand, and then compresses this HTML and forwards the compressed version to the mobile terminal. According to Opera, Opera Mobile Accelerator reduces the size of Web pages by approximately 50-70%, but it has the ability to reduce them up to 90%. With this in mind, the data is retrieved faster and the Web pages are displayed sooner. Generally, the increase in speed depends on the type of sites you are visiting. These two technologies present partial solutions to the problems of mobile terminal display size and bandwidth in connection with Web browsing. However, there is a need in the art for an improved system and method for providing web page data to digital devices having limited bandwidth or other communication and/or processing power limitations.

### SUMMARY OF THE INVENTION

According to one aspect, the present invention discloses a method, that may include accessing an Internet site by a proxy server; converting image data from the Internet site into a multiresolution representation; and transmitting the image data in the multiresolution representation to a client device. Preferably, the method further includes

navigating a web page by the client device. Preferably, the navigating step includes (a) navigating the Internet site image data by the proxy server; and (b) navigating the multiresolution image data by the client device, wherein the navigating of step (a) and the navigating of step (b) occur substantially simultaneously.

Preferably, the navigating includes storing multiresolution image data for at least substantially the entirety of the web page at the proxy server; and navigating the stored multiresolution image data by the client device. Preferably, the converting step comprises: continuously converting the Internet site image data as needed by the navigating by the client device. Preferably, the converting step comprises: pre-converting selected image data from the Internet site by the proxy server prior to the selected image data being needed for the client device navigation; and storing the pre-converted image data at the proxy server.

Preferably, the method further comprises transmitting the stored image data to the client device as needed by the client device navigation. Preferably, the method further includes ensuring that the stored pre-converted image data is not stale prior to transmission thereof to the client device. Preferably, the ensuring step includes comparing one of a timestamp and a checksum of the pre-converted image data with a respective one of a timestamp and a checksum of corresponding image data originating from the Internet site. Preferably, the pre-converting step includes converting image data for at least one web page by the proxy server; and storing the converted image data for the at least one web page at the proxy server.

Preferably, the method further includes enabling bi-directional interactive communication between the client device and the Internet site. Preferably, the interactive communication comprises: transmitting navigation commands from the client device to the proxy server. Preferably, the method further includes emulating dynamic Internet graphics for the client device by the proxy server. Preferably, the emulating step comprises emulating at least one of: dynamic HTML (Hypertext Markup Language); and applets. Preferably, the navigating comprises: selecting a resolution level at which to view at least a portion of the web page, at the client device.

Preferably, the navigating includes selecting a region of the web page for display on the client device. Preferably, the navigating further includes selecting a resolution at which to view the region of the web page. Preferably, the navigating step comprises selecting a plurality of portions of the web page for viewing at the client device. Preferably, the navigating step further includes selecting a plurality of respective resolutions at which to view the plurality of web page portions. Preferably, navigating the multiresolution image data includes panning the multiresolution image data. Preferably, the navigating the multiresolution image data comprises: zooming in on the multiresolution image data.

According to another aspect, the invention may provide an apparatus, that may include a client device; and a proxy server in communication with, and serving as an intermediary between, the client device and an Internet site, wherein the proxy server is operable to convert image data from the Internet site into a multiresolution visual data format. Preferably, the multiresolution visual data format is JPEG2000. Preferably, the client device is a cell phone, and wherein the cell phone comprises: at least one mechanism for navigating image data in the multiresolution visual data format. Preferably, the mechanism is a touchpad and the touchpad enables panning image data in the multiresolution visual data format. Preferably, the mechanism enables zooming in on image data in the multiresolution visual data format. Preferably, the mechanism for zooming comprises a roller that is rotatable by a user of the client device. Preferably, the client device is one of the group consisting of: a cell phone, a PDA (Personal Digital Assistant), a notebook computer, a desktop computer, a tablet computer, and a television set.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a bock diagram of a communication system including a proxy server and a client device in accordance with one or more embodiments of the present invention;

FIG. 2A is a front view of a client device, which may be a cell phone, customized in accordance with one or more embodiments of the present invention;

FIG. 2B is an elevational view of the back of a client device, which may be a cell phone, customized in accordance with one or more embodiments of the present invention;

FIG. 2C is an elevational view of the back of a client device, which may be a cell phone, customized in accordance with one or more embodiments of the present invention;

FIG. 3 is a flowchart of a method for navigating image data by a client device in accordance with one or more embodiments of the present invention;

FIG. 4 is a view of a web page column as seen on a client device in accordance with one or more embodiments of the present invention;

FIG. 5A is a view of the web page of FIG. 4 after about two seconds of loading at a rate of 20 kilobits per second, in accordance with one or more embodiments of the present invention;

FIG. 5B is a view of the web page of FIG. 4 after about ten seconds of loading at a rate of 20 kilobits per second, in accordance with one or more embodiments of the present invention;

FIG. 6A is a view of a top portion of the web page of FIG. 4 after loading data at 20 kilobits per second for about two seconds, in accordance with one or more embodiments of the present invention;

FIG. 6B is a view of a top portion of the web page of FIG. 4 after loading data at 20 kilobits per second for about ten seconds, in accordance with one or more embodiments of the present invention;

FIG. 7 is a zoomed in view of a portion of the web page of FIG. 4 captured shortly after capture of the views of FIG. 6, in accordance with one or more embodiments of the present invention;

FIGS. 8A and 8B are portrait and landscape views, respectively, of a portion of the web page of FIG. 4, in accordance with one or more embodiments of the present invention; and

FIG. 9 is a block diagram of a computer system adaptable for use with one or more embodiments of the present invention.

### DETAILED DESCRIPTION OF THE PREFERRED EMBODIMENTS

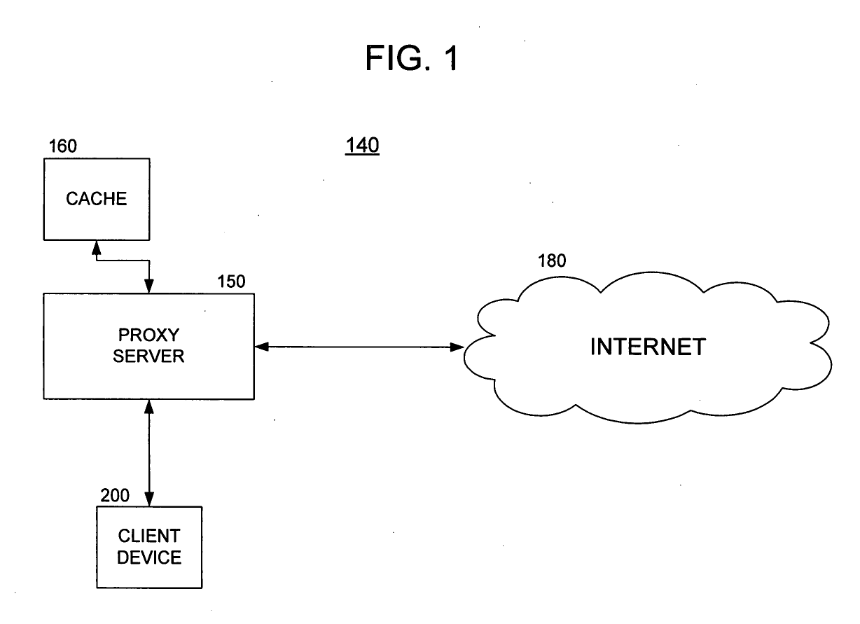

FIG. 1 is a bock diagram of a communication system 140 including a proxy server 150 and a client device 200 in accordance with one or more embodiments of the present invention. Communication system 140 may include Internet 180, client device 200, and proxy server 150, which may in turn include cache 160. Internet 180 may interpreted to include communication links and computing and communication hardware needed to enable proxy server 150 to browse the Internet in a conventional manner. While a high-bandwidth connection is preferred for use between proxy server 150 and Internet 180, any communication link, such as is known in the art, may be used to connect proxy server 150 to Internet 180. Generally, proxy server 150 may be connected to an Internet Service Provider (ISP) (not shown) which serves as a gateway to the Internet as a whole. In one or more embodiments herein, Internet 180 is intended to include such an Internet Service Provider.

Proxy server 150 may be a personal computer or other computing device suitably configured to communicate with the Internet and to process data, including image data, downloaded therefrom. Proxy server 150 is preferably able to transmit commands to and receive image data from Internet 180.

Proxy server 150 may include cache 160 for storing data, including image data, to enable rapid and easy access to such data. Cache 160 may be physically incorporated within server 150, such as by being within the same physical enclosure as proxy server 150. Alternatively, cache 160 may be housed separately from proxy server 150 but be accessible to cache 160.

Client device 200 is preferably a portable computing device able to conduct communication with proxy server 150. However, client device could be a larger, non-portable computing device, such as a desktop computer. Client device 200 may be one of a cell phone, a Personal Digital Assistant (PDA), a notebook computer, a desktop computer, a tablet computer, and a television set. However, client device 200 is not limited to being one of the foregoing items. Preferably, if client device 200 is a television set, this television set is able receive multiresolution image data and to transmit navigation commands to an external device, such as, but not limited to proxy server 150. Client device 200 may also include a data storage capability, including volatile and/or non-volatile storage, for storing multiresolution image data received from proxy server 150. Such data storage may include but is not limited to: RAM (Random Access Memory, ROM (Read Only Memory), hard drive, CD-ROM drive, CD read-write, and bubble memory. Where desired, the client device 200 data storage may include cache memory.

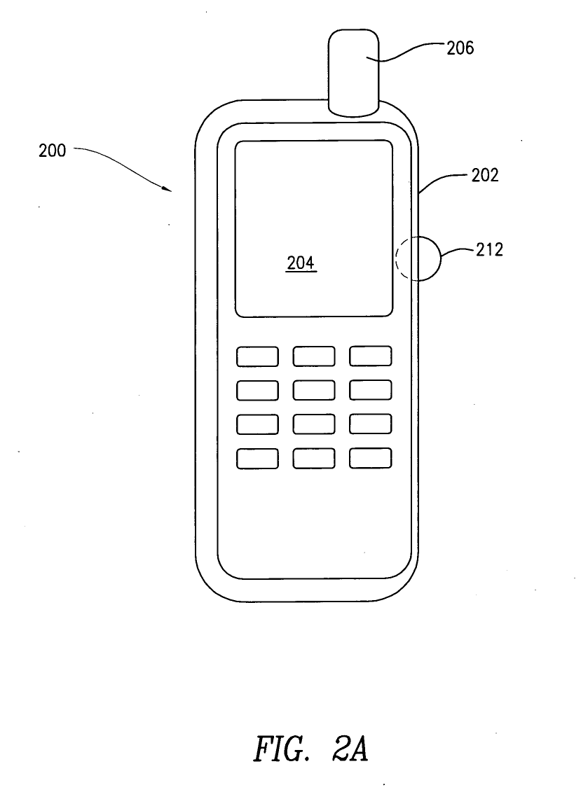

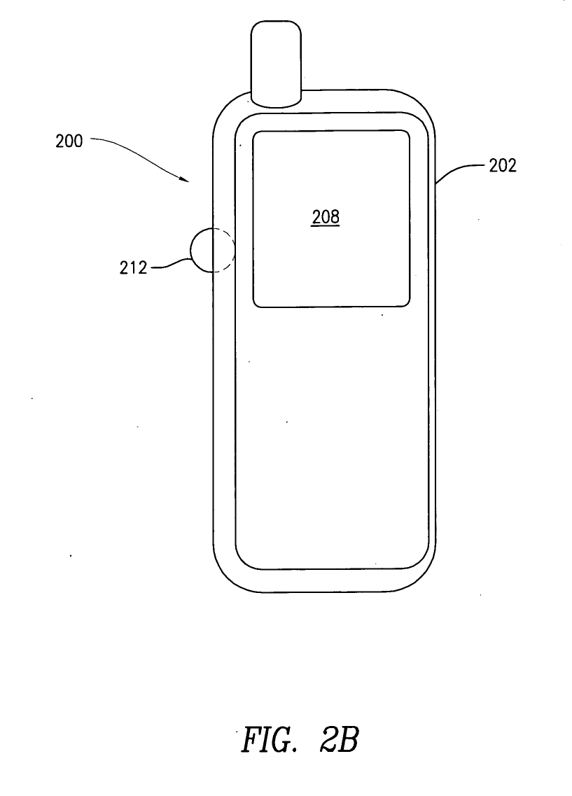

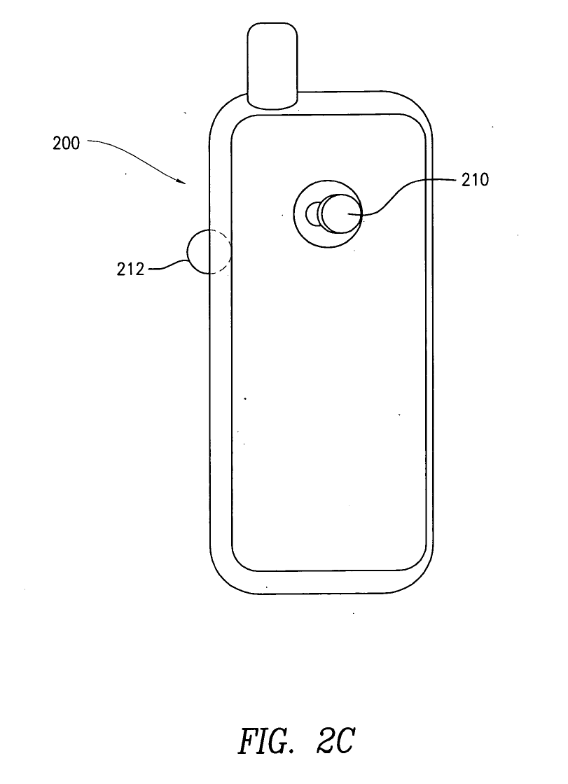

Proxy server 150 may serve as an intermediary between Internet 180 and client device 200 to enable client device 200 to browse image data from Internet 180 after conversion of such data into a multiresolution format, as discussed in greater detail in connection with FIG. 2.

FIG. 2A is a front view of client device 200, which may be a cell phone, customized in accordance with one or more embodiments of the present invention. FIG. 2B is an elevational view of the back of the client device 200 of FIG. 2A. And, FIG. 2C is an elevational view of the back of the client device of FIG. 2A.

In one or more embodiments covered by the illustrations of FIG. 2, client device 200 is a cell phone or PDA that is specially configured for browsing multiresolution image data. Client device 200 may include a body 202, a display 204, an antenna 206, a touchpad 208, a joystick 210, and/or a roller 212. In FIG. 2, roller 212 is shown protruding to some extent from body 202 of client device 200. This protrusion is shown for illustrative purposes. Roller or wheel 212 need only be accessible to a user of client device 200. Thus, it may protrude from body 202 very slightly. Alternatively, a recess (not shown) in the side of body 202 may be provided into which wheel 212 is nested, thereby enabling wheel 212 to not protrude beyond the straight-edged portion of the side of body 202 of client device 200.

In one or more embodiments, display 204 may be located on the front of client device 200 (FIG. 2A). However, in other embodiments, display 204 may be located anywhere on client device 200. Touchpad 208 may be located on the rear of client device 200 (FIG. 2B) and may be used for panning image data received from proxy server 150. However, alternatively, touchpad 208 may be located on any surface of client device 200. Alternatively, touchpad 208 may be used for zooming image data. In one or more other embodiments, touchpad 208 may be used for panning and zooming image data.

A user of client device 200 may pan or zoom image data by moving a finger along the surface of touchpad 208. Additionally or alternatively, touchpad 208 may be employed to move a cursor over one or more image regions or web page regions displayed on display 204. Where plural images (possibly but not necessarily from two different web pages) are displayed on display 204, use of a cursor may be beneficial for identifying one of the images for the purpose of performing a navigation step thereon.

In an alternative embodiment, joystick 210 (FIG. 2C) may be employed for panning image data either in addition to, or in place of touchpad 208. Joystick may be used for panning image data by pushing the joystick 210 in a direction corresponding to a direction in which a user of client device 200 wishes to pan across an image. As with touchpad 208, joystick 210 may be located on any surface of client device 200.

In one or more embodiments, zooming may be accomplished using a separate device, such as wheel 212, or other device such as a slider (not shown), or using a stereotyped gesture on touchpad 208, such as sliding the finger up and down one edge of the touchpad 208 surface. In the latter case, both index fingers could be used on the touchpad simultaneously, one panning and the other zooming.

In one or more embodiments that include both touchpad 210 and wheel 212, a user of client device 200 could rapidly switch back and forth between zooming and panning, or even pan and zoom simultaneously. Herein, wheel 212 may also be referred to as a “roller.”

Employing one or more of the above-described features, panning and/or zooming may become tactile experiences, as though a user of client device 200 were looking through the display (screen) 204 at a larger surface. The index finger of one hand could stroke touchpad 208, panning the image and providing a sense that the larger image is being moved from behind display 204 using touchpad 208. In an analogous manner, the use of wheel 212 for zooming in on an image may be employed to provide a sense that movement of wheel 212 moves the “larger image” closer to or further away from display 204, depending upon the direction of rotation of wheel 212.

The haptic interface described above may provide a natural and familiar “feel” with a shallow learning curve. One or more embodiments may also provide the advantage, compared to the more conventional solution of using a touchscreen, of allowing an unobstructed view of the display while the finger strokes touchpad 208 to pan an image. Moreover, in or more embodiments, synergistic benefits may be obtained by being able to readily alternate between panning and zooming and/or to conduct these two activities simultaneously or substantially simultaneously, whether using touchpad 208 and wheel 212, or using other navigation mechanisms.

In one or more embodiments, touchpad 208 may have dimensions of about 2 inches by 1.5 inches, however touchpad 208 may be smaller or larger in either dimension than the listed values.

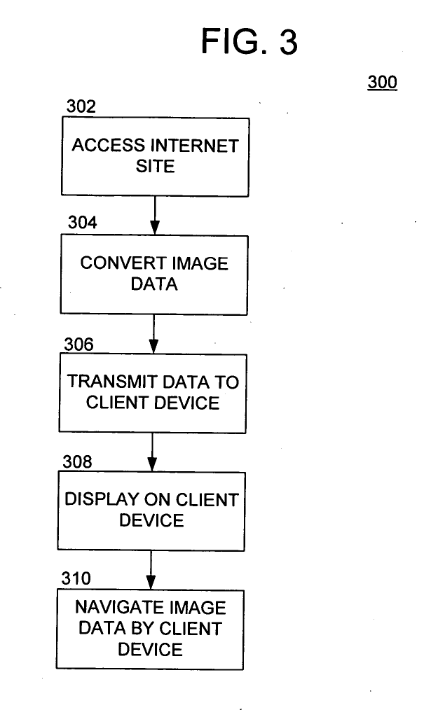

FIG. 3 is a flowchart of a method 300 for navigating image data by a client device 200 in accordance with one or more embodiments of the present invention. The steps shown in FIG. 3 are not limited to being performed in the order shown. In certain cases, two or more of the illustrated steps may be performed simultaneously. In the following, the steps are listed and summarized, following which the application of the steps to basic interactive browsing and the variations thereof are discussed.

Method 300 may include accessing 302 an Internet site at Internet 180 by proxy server 150. Proxy server may convert 304 image data from the accessed internet site into a multiresolution visual data format that supports spatial random access (multiresolution image data). JPEG2000 is one possible example of such a visual data format. However, the present invention is not limited to the use of this standard. Herein, the term “converting” generally corresponds to the term “repackaging,” as applied to turning ordinary web page data into multiresolution image data.

Method 300 may include transmitting 306 the multiresolution image data to client device 200 by proxy server 150, for ultimate display 308 on client device 200. Client device 200 may navigate 310 the transmitted multiresolution image data, either after or concurrently with the transmission in step 306. The transmitted multiresolution image data navigated 310 by client device 200 may include emulated Internet graphical features, such as, but not limited to dynamic HTML and applet functionality.

In one embodiment, proxy server 150 converts 304 image data from web pages on Internet 180 into multiresolution image data, as such data is needed by the navigation 310 of client device 200.

The multiresolution image data is then preferably transmitted 306 to client device 200 and displayed 308 thereon. In this embodiment, the accessing 302 of the Internet site, which may be a web page, by proxy server 150 and the navigation of the multiresolution image data by client device 200 may occur substantially simultaneously. Thus, in this embodiment, the conversion 304 of web page (or other type of) image data occurs substantially “on the fly” in response to the navigation 310 conducted by client device 200. Navigation 310 may include but is not limited to panning and zooming by client device 200.

In another embodiment, proxy server may convert, or “pre-convert”, one or more entire web pages, or other form of Internet image data, into multiresolution image data and store the converted data in cache 160, or other memory device accessible to proxy server 150, for ready accessibility by, and transmission to, client device 200. This pre-conversion may be performed prior to the web page data concerned being needed in response to client device 200 navigation 310 commands.

In one or more embodiments, proxy server 150 may ensure that, when servicing a request for image data from client device 200, the cached pre-converted multiresolution image data isn't “stale” by verifying that the original HTML content is unaltered in comparison with the cached version. This verification may be accomplished by comparing timestamps, checksums, or by using other well-known methods. Some tolerance for “staleness” may be built in to bound the number of HTML requests the proxy server must make. In this disclosure, data that is not “stale” is “fresh.”

In one or more embodiments, proxy server 150 serves as an intermediary between the Internet 180, or more specifically a site or Internet page of Internet 180, and client device 200. Consequently, proxy server 150's communication with the Internet 180 is preferably responsive to the browsing of multiresolution image data by client device 200. Also, two or more of the steps illustrated in FIG. 3 may occur interactively and/or concurrently rather than occurring one at a time and strictly in the sequence shown.

Generally, web page image data flows from Internet 180 to proxy server 150 where it may be converted into multiresolution image data. At that point, the multiresolution image data may be stored in cache 160 and/or transmitted to client device 200 for display thereon. Client device may, where needed, store the received multiresolution image data.

Navigation or browsing commands generally proceed in the reverse direction. Specifically, navigation requests and/or other commands pertinent to browsing a-web page or Internet site may originate at client device 200, proceed to proxy server 150 and thereafter may be sent, possibly in modified form, from proxy server 150 to the Internet 180. Suitable conversion or reconfiguration of commands received at proxy server 150 from client device 200 may be implemented at proxy server 150 before re-transmitting such commands to the Internet 180. For example, where client device 200 clicks on a link to another web page, proxy server 150 may re-transmit this linking command to the Internet 180 in order to access the target web page. The commands that may be sent by client device 200 may include navigation commands such as panning and zooming. Further commands may include clicking with a mouse or other device, typing, speaking (where voice commands may be understood at client device 200), gesturing, movement of a finger or implement along the surface of touchpad 208, movement of wheel 212, or movement of joystick 210.

A first example is considered in which a single web page is accessed 302, converted 304 into multiresolution image data, and stored in cache 160. After being stored in cache 160, the multiresolution image data may be browsed as needed by client device 200.

Continuing with the example, let us suppose that client device 200 receives a initial rendition of the converted web page at a low resolution level. From this starting point (“resolution level 1”), the user of client device 200 zooms in on a selection region “A” of the web page. Assuming that client device does not have the higher-resolution image data in its local storage, the zoom command is preferably transmitted to proxy server 150 which may retrieve the needed data from cache 160 and which may transmit this image data to client device 200.

Preferably, the extent of the zoom requested by client device 200 may be associated with a selected resolution level (“resolution level 2” for the sake of this example) by proxy server 150. The resulting resolution level may be selected from one of a set of pre-defined resolution levels of the selected region (region “A”). Alternatively, if the selected resolution level does not precisely correspond to one of the pre-defined resolution levels, the requested resolution level may calculated by conducting one or more interpolation calculations as disclosed in a document incorporated herein.

Display 204 of client device 200 then preferably shows the selected region “A” at the selected resolution. Presumably, substantially only region A of the converted web page is then displayed on display 204.

Continuing with the example, we consider a situation where the user of client device 200 next wishes to pan laterally from region “A” to region “B” (regions are not shown) within a web page, while preferably maintaining the resolution level last used to display region “A” (“resolution level 2”). Assuming that the multiresolution image data for region “B” is not available within client device 200, the step of panning toward region “B” preferably causes proxy server 150 to seek the image data for region “B” from cache 160, or other data storage device accessible to proxy server 150, and to transmit this data to client device 200. Upon receiving this data, client device 200 should be able to display region “B” at “resolution level 2”. It is noted that, if the image data for resolution level 2 had not been available in cache 160, proxy server 150 would preferably have again accessed the pertinent web page from Internet 180, and converted data for that web page into multiresolution image data having greater resolution than that stored in cache 160.

Continuing with the example, we next consider a situation in which a user of client device 200 wishes to activate a hyperlink within the first web page, preferably within region B of the first web page.

As the user of client device 200 clicks on the hyperlink, proxy server 150 may determine that the web page image data associated with the hyperlink is not located in cache 160. Accordingly, proxy server 150 preferably replicates the request for the hyperlink's target web page in its communication with Internet 180.

Preferably, proxy server 150 then accesses the hyperlink's target web page. Proxy server 150 may then convert image data from the target web page into multiresolution image data and dynamically stream the multiresolution image data to client device 200 for display thereon. Alternatively or additionally, proxy server 150 may store all or part of the multiresolution image data for the target web page in cache 160 for later access, as needed, by client device 200. Such storage in cache 160, or other suitable storage device, may be beneficial since client device 200 may not be able to receive and display all of the multiresolution image data for the target (hyperlinked) web page at once. This inability is more likely to be present where client device 200 has selected a high resolution level at which to view one or more regions of the target web page. It is noted that, in general, the higher the resolution (of a displayed region) at which client device displays multiresolution image data, the smaller the displayed region will be.

In one or more embodiments, client device 200 may be able to display plural regions of a web page, or plural regions drawn from a plurality of respective web pages. In this case, client device 200 is preferably able to independently select display resolutions for each such displayed region. In this case, touchpad 208 or other mechanism within client device 200 is preferably able to move a cursor over each image, in turn, for the purpose of selecting a desired resolution for each such image.

Moreover, within any one image, which image may form only a portion of a web page, the resolution need not be constant. The resolution may vary as needed to reconcile the competing priorities of viewing a region of interest at high resolution and avoiding the data storage and data communication burden of receiving the amount of multiresolution image data needed to display an entire image at high resolution.

One or more embodiments of the approach described herein for Web browsing by proxy may provide the features discussed below.

As discussed above, a zooming function may be provided with web browsing by proxy. Thus, a Web page formatted for viewing a wider display than that of client device 200 can nonetheless be seen in its full column width on a small display, such as display 204. If the text is small relative to the column size, it may be beneficial to pan horizontally to read single lines in their entirety. However, the use of continuous zooming may enable many text columns to be read in their entirety even on a 176 pixel wide display (which width is featured on certain commercially available mobile phones).

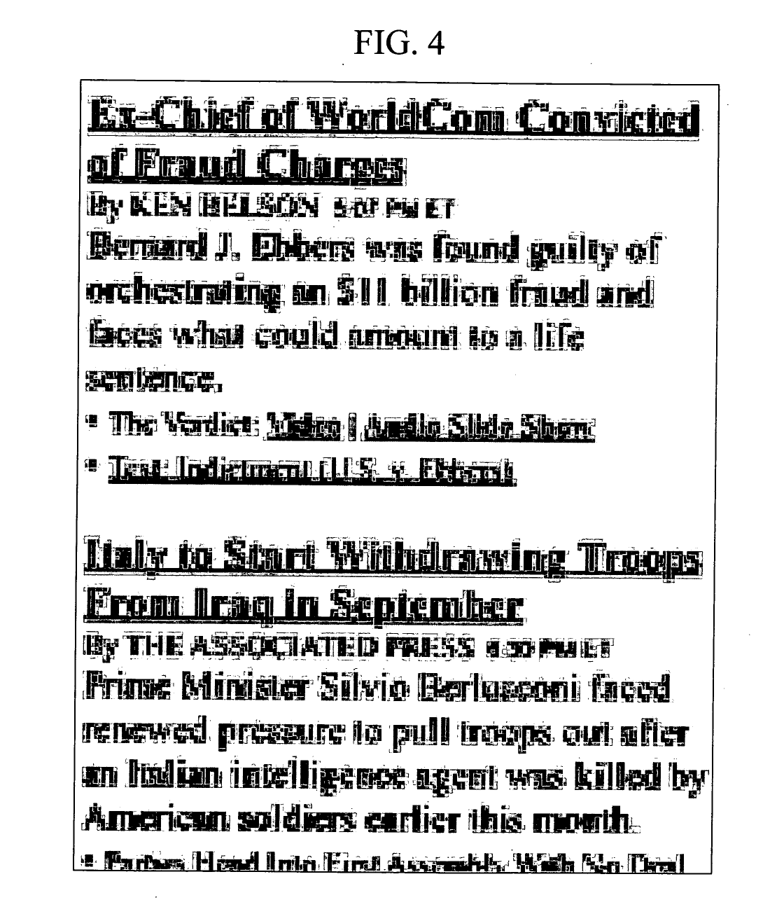

In one or more embodiments, this is possible without any reformatting, which would alter the layout of the Web page. FIG. 4 shows a column of a Web page (originally designed for viewing on an 800×200 pixel display) being viewed in this fashion.

Provided that either conversion to multiresolution image data format is reasonably fast or that cached multiresolution image content is already available at cache 160, an initial view of an entire Web page can be rendered visible at client device 200 shortly after requesting the pertinent web page. This ability may be provided for Web pages of any length. It also applies whether the initial view of the Web page is a zoomed-out overview of the entire page or a zoomed-in view of the top (or any other part) of the web page.

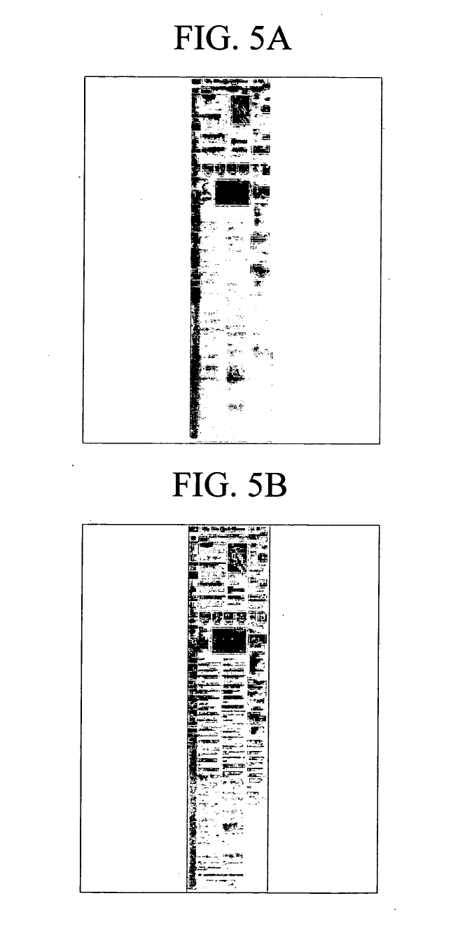

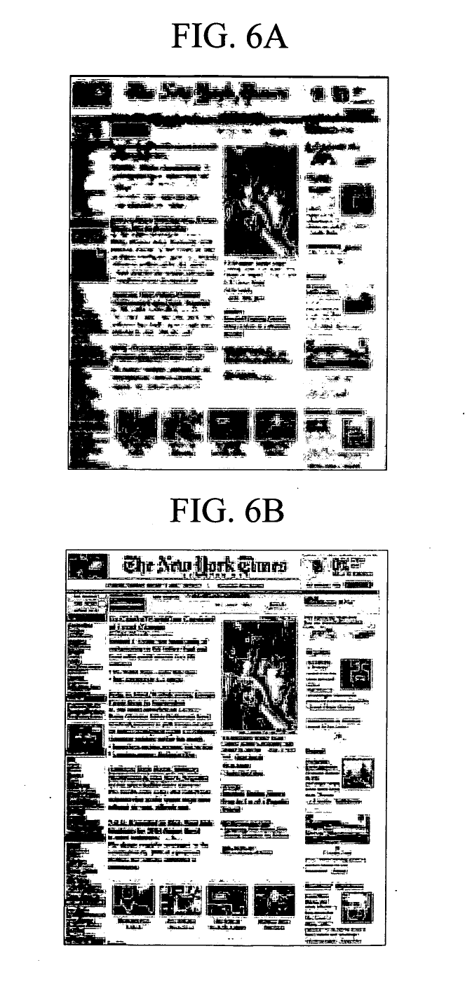

FIGS. 5A and 6A illustrate these situations, providing general overviews and a top views, respectively, of a large Web page after about 2 seconds of loading over a 20 kilobit/second connection. FIGS. 5B and 6B show clearer versions of FIGS. 5A and 6A, respectively, after about ten seconds of data loading time.

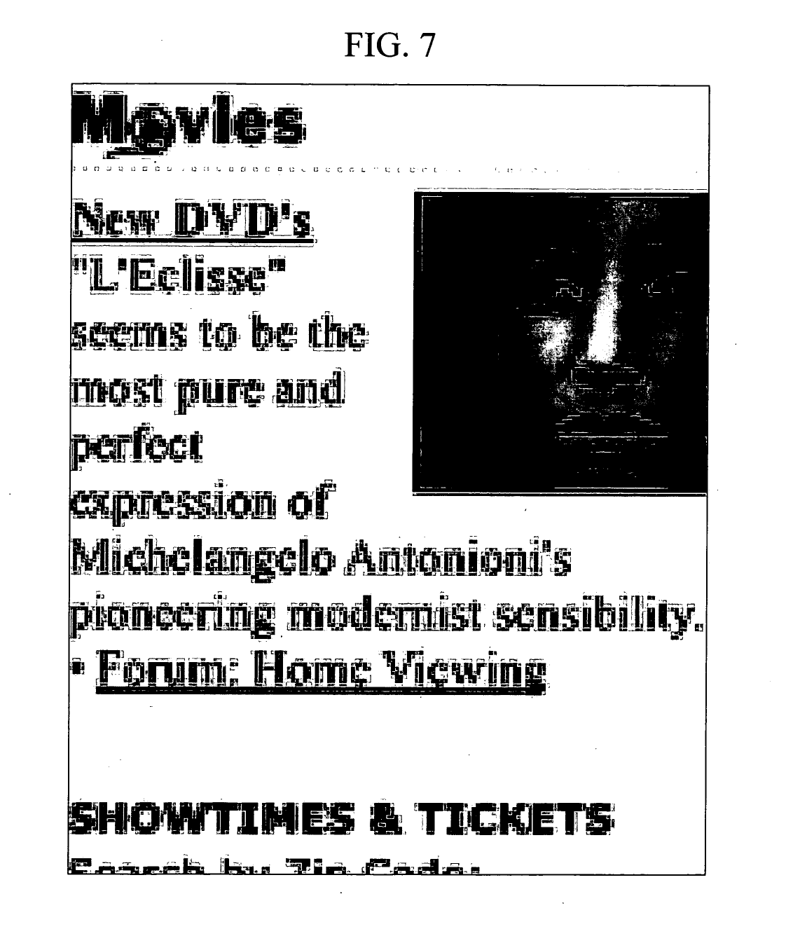

For complex Web pages with a variety of content, such as newspapers, the client can continuously focus in on interesting areas immediately, without waiting for the entire document to download. See FIG. 7.

Web pages of virtually unlimited length may be viewed without taxing the resources of client device 200, without delaying the time to initial view, and without causing degraded performance.

In one or more embodiments, a Web page may have very large images, which client device 200 may zoom in on to see fine details of, without taxing client device 200's resources, without delaying the time to initial viewing of the web page, and/or without resulting in degraded performance.

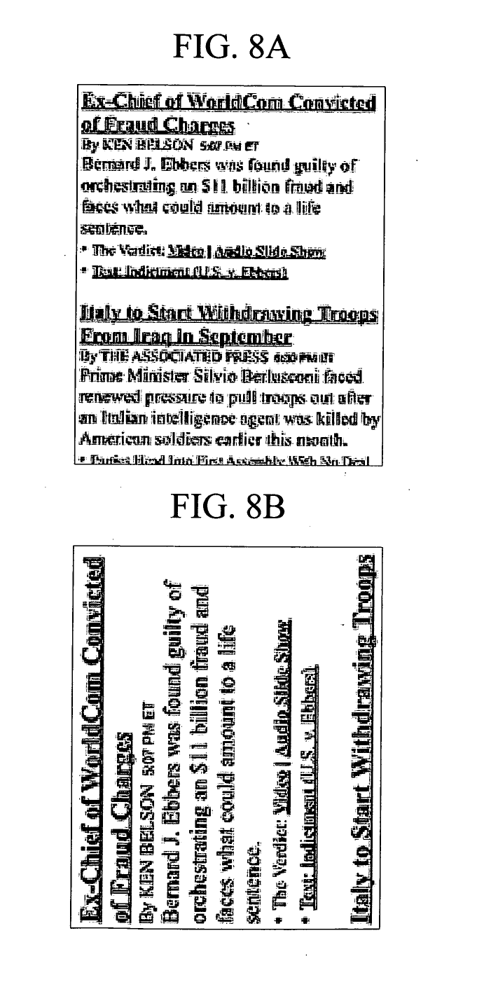

In some cases, small device displays are taller than they are wide (e.g. 176 pixels wide by 220 pixels high for the Samsung® SGH-D410 mobile phone). Yet for Web browsing, the most constraining variable may be column width, making it desirable for the cellular display to use a “landscape” rather than a “portrait” page setup. Because multiresolution image data allows rotation of visual content by a selectable angular distance, the larger dimension of the display can be used to its greatest effect during content browsing. See FIGS. 8A and 8B.

In one or more embodiments, a client device 200 accessing multiresolution image data may be enabled to view image content originating on any server having access to multiresolution image data, not only the multiresolution image data generated by proxy server 150. Thus, such a client device 150 may be enabled to continuously navigate large numbers of large images, large multiresolution vectorial maps, and other kinds of image content that might be difficult or impossible to serve using conventional HTML.

The above-listed advantages m ay be compelling enough to make multiresolution image data browsing using proxy server 150 beneficial not only for cellular phone users, but also for users of larger devices, including, but not limited to: PDA or palmtop wireless devices; notebook computers with wireless internet; home computer users connected to the internet via a narrowband connection such as a modem; and/or home broadband users.

In the case of home broadband users, one or more embodiments of a system using proxy server 150 to transmit multiresolution image data to client device 200 may provide features that include but are not limited to the following:

a) Web pages may be zoomed continuously to improve legibility of small type or examine details of images;

b) web pages designed for a small display could be browsed in sharp detail (for text or vector components) on a high-resolution display;

c) multiple Web pages could be rearranged, manipulated and resized in a rich 2D (two-dimensional) or 3D (three-dimensional) multiscale environment, providing alternative user experiences to conventional multi-window or tabbed browsing; and/or

d) through the judicious use of proxy server 150 caching, potentially unlimited numbers of Web pages could be aggregated into live large-scale “views” of the Web, without requiring excessive client device 200 memory or other resources.

Finally, because displaying images in a multiresolution image data format may provide complementary advantages for large-display, high-bandwidth platforms and small-display, low-bandwidth platforms, displaying in this manner may unify user experience and may simplify cross-platform engineering and development, rather than requiring different versions of visual content and/or browsers to be provided for the different platforms.

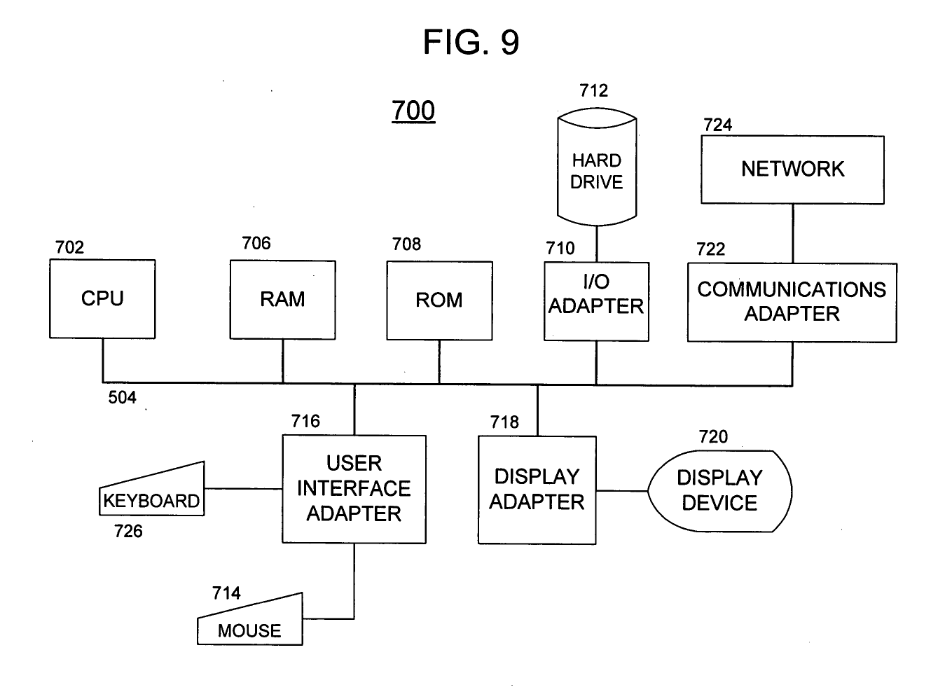

FIG. 9 is a block diagram of a computing system 700 adaptable for use with one or more embodiments of the present invention. In one or more embodiments, central processing unit (CPU) 702 may be coupled to bus 704. In addition, bus 704 may be coupled to random access memory (RAM) 706, read only memory (ROM) 708, input/output (I/O) adapter 710, communications adapter 722, user interface adapter 706, and display adapter 718.

In one or more embodiments, RAM 706 and/or ROM 708 may hold user data, system data, and/or programs. I/O adapter 710 may connect storage devices, such as hard drive 712, a CD-ROM (not shown), or other mass storage device to computing system 700. Communications adapter 722 may couple computing system 700 to a local, wide-area, or Internet network 724. User interface adapter 716 may couple user input devices, such as keyboard 726 and/or pointing device 714, to computing system 700. Moreover, display adapter 718 may be driven by CPU 702 to control the display on display device 720. CPU 702 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
accessing an Internet site by a proxy server;
converting image data from said Internet site into a multiresolution representation; and
transmitting said image data in said multiresolution representation to a client device.

2. The method of claim 1 further comprising:
navigating a web page by said client device.

3. The method of claim 2 wherein said navigating comprises:
(a) navigating said Internet site image data by said proxy server; and
(b) navigating said multiresolution image data by said client device, wherein said navigating of step (a) and said navigating of step (b) occur substantially simultaneously.

4. The method of claim 2 wherein said navigating comprises:
storing multiresolution image data for at least substantially the entirety of said web page at said proxy server; and
navigating said stored multiresolution image data by said client device.

5. The method of claim 2 wherein said converting step comprises:
continuously converting said Internet site image data as needed by said navigating by said client device.

6. The method of claim 2 wherein said converting step comprises:
pre-converting selected image data from said Internet site by said proxy server prior to said selected image data being needed for said client device navigation; and
storing said pre-converted image data at said proxy server.

7. The method of claim 6 further comprising:
transmitting said stored image data to said client device as needed by said client device navigation.

8. The method of claim 6 further comprising:
ensuring that said stored pre-converted image data is not stale prior to transmission thereof to said client device.

9. The method of claim 8 wherein said ensuring comprises:
comparing one of a timestamp and a checksum of said pre-converted image data with a respective one of a timestamp and a checksum of corresponding image data originating from said Internet site.

10. The method of claim 6 wherein said pre-converting step comprises:
converting image data for at least one web page by said proxy server; and
storing said converted image data for said at least one web page at said proxy server.

11. The method of claim 2 further comprising:
enabling bi-directional interactive communication between said client device and said Internet site.

12. The method of claim 11 wherein said interactive communication comprises:
transmitting navigation commands from said client device to said proxy server.

13. The method of claim 2 further comprising:
emulating dynamic Internet graphics for said client device by said proxy server.

14. The method of claim 13 wherein said emulating step comprises emulating at least one of:
dynamic HTML (Hypertext Markup Language); and
applets.

15. The method of claim 2 wherein said navigating comprises:
selecting a resolution level at which to view at least a portion of said web page, at said client device.

16. The method of claim 2 wherein said navigating comprises:
selecting a region of said web page for display on said client device.

17. The method of claim 16 wherein said navigating further comprises:
selecting a resolution at which to view said region of said web page.

18. The method of claim 2 wherein said navigating comprises:
selecting a plurality of portions of said web page for viewing at said client device.

19. The method of claim 18 wherein said navigating further comprises:
selecting a plurality of respective resolutions at which to view said plurality of web page portions.

20. The method of claim 2 wherein said navigating said multiresolution image data comprises:
panning said multiresolution image data.

21. The method of claim 2 wherein said navigating said multiresolution image data comprises:
zooming in on said multiresolution image data.

22. An apparatus, comprising:
a client device; and
a proxy server in communication with, and serving as an intermediary between, said client device and an Internet site, wherein said proxy server is operable to convert image data from said Internet site into a multiresolution visual data format.

23. The apparatus of claim 22 wherein said multiresolution visual data format is JPEG2000.

24. The apparatus of claim 2 wherein said client device is a cell phone,-and wherein said cell phone comprises:
at least one mechanism for navigating image data in said multiresolution visual data format.

25. The apparatus of claim 24 wherein said mechanism is a touchpad and said touchpad enables panning image data in said multiresolution visual data format.

26. The apparatus of claim 22 wherein said mechanism enables zooming in on image data in said multiresolution visual data format.

27. The apparatus of claim 26 wherein said mechanism for zooming comprises a roller that is rotatable by a user of said client device.

28. The apparatus of claim 22 wherein said client device is one of the group consisting of: a cell phone, a PDA (Personal Digital Assistant), a notebook computer, a desktop computer, a tablet computer, and a television set.
